(19) United States
(12) Patent Application Publication
(10) Pub. No.: US 2026/0087836 A1
(43) Pub. Date: Mar. 26, 2026

(54) DOMAIN-AGNOSTIC ANNOTATION FRAMEWORK

(71) Applicant: QUALCOMM Incorporated, San Diego, CA (US)

(72) Inventors: Avani RAO, Bangalore (IN); Wei-Lun CHANG, Hsinchu (TW); T M Feroz ALI, Thrissur (IN); Srenivas VARADARAJAN, Bangalore (IN); Michel Adib SARKIS, San Diego, CA (US)

(21) Appl. No.: 18/895,161

(22) Filed: Sep. 24, 2024

(51) Int. Cl. G06V 20/70; G06V 10/44; G06V 10/74

(52) U.S. Cl. CPC G06V 20/70; G06V 10/44; G06V 10/761

(57) ABSTRACT

Systems and techniques are provided for image processing. For instance, a process can include identifying a keyframe from a received sequence of frames based on differences between features of frames of the received sequence of frames; receiving an annotation for the keyframe; identifying a first set of frames from the received sequence of frames based on differences between features of frames in the received sequence of frames and features of the keyframe; and generating annotated frames by extrapolating the annotation for the keyframe to the first set of frames.

### FIELD

The present application is related to training machine learning (ML) models. For example, aspects of the present application relate to systems and techniques for a domain agnostic annotation framework for training ML models.

### BACKGROUND

Many devices and systems utilize 3D technology for a wide variety of different use cases, including mobile devices (e.g., mobile phones), extended reality (XR) systems (e.g., virtual reality (VR), augmented reality (AR), and/or mixed reality (MR)), vehicles (e.g., autonomous or semi-autonomous vehicles), robotics systems, among others. Such systems can include sensors that capture frames of data (e.g., image frames or other type of data) of an environment. The data can be used to reconstruct a 3D scene of the environment using a 3D reconstruction (3DR) techniques. In one illustrative example, a virtual environment for an extended reality (XR) system (e.g., a virtual reality (VR) system, an augmented reality (AR) system, and/or mixed reality (MR) system) may be populated based on digital replication of a real world environment. The digital replication of the real world environment can be generated using 3DR techniques, and can be used to model, simulate, change, better understand, etc. the real world environment and/or object(s) in the environment.

3DR techniques, along with other computer vision (CV) techniques may be based on machine learning (ML) models (e.g., deep learning (DL) neural network models). These ML models may be trained, for example, using labelled ground truth information. Training a ML model prior to putting the ML model into use helps adjust parameters of the ML model better perform certain task(s). The ML model may be trained to perform the task(s) using training data from which the ML model may generalize from to perform the task(s) on new data during inference. In some cases, the training data may include images with annotations. The annotations may be labels in the image indicating what task the ML model may learn to perform. For example, an image may be annotated with a bounding box around certain objects for object detection, keypoints of an object may be identified for pose detection, a boundary drawn around an object for semantic segmentation, and so forth. Traditionally, annotating images (e.g., frames) may be performed manually and annotations for video may be performed for each image (e.g., frame) of the video. As a result, annotating video clips may be labor intensive, time consuming, and/or expensive.

### SUMMARY

Systems and techniques are described herein for annotating data such as images. The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems and techniques for annotating data are provided. In one illustrative example, an apparatus for image processing is provided. The apparatus includes at least one memory; and at least one processor coupled to the at least one memory. The at least one processor is configured to: identify a keyframe from a received sequence of frames based on differences between features of frames of the received sequence of frames; receive an annotation for the keyframe; identify a first set of frames from the received sequence of frames based on differences between features of frames in the received sequence of frames and features of the keyframe; and generate annotated frames by extrapolating the annotation for the keyframe to the first set of frames.

As another example, a method for annotating data is provided. The method includes: identifying a keyframe from a received sequence of frames based on differences between features of frames of the received sequence of frames; receiving an annotation for the keyframe; identifying a first set of frames from the received sequence of frames based on differences between features of frames in the received sequence of frames and features of the keyframe; and generating annotated frames by extrapolating the annotation for the keyframe to the first set of frames.

In another example, a non-transitory computer-readable medium having stored thereon instructions is provided. The instructions, when executed by at least one processor, cause the at least one processor to: identify a keyframe from a received sequence of frames based on differences between features of frames of the received sequence of frames; receive an annotation for the keyframe; identify a first set of frames from the received sequence of frames based on differences between features of frames in the received sequence of frames and features of the keyframe; and generate annotated frames by extrapolating the annotation for the keyframe to the first set of frames.

For another example, an apparatus for annotating data is provided. The apparatus includes: means for identifying a keyframe from a received sequence of frames based on differences between features of frames of the received sequence of frames; means for receiving an annotation for the keyframe; means for identifying a first set of frames from the received sequence of frames based on differences between features of frames in the received sequence of frames and features of the keyframe; and means for generating annotated frames by extrapolating the annotation for the keyframe to the first set of frames.

In some aspects, one or more of the apparatuses described herein comprises a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device of a vehicle), or other device. In some aspects, the apparatus(es) includes at least one camera for capturing one or more images or video frames. For example, the apparatus(es) can include a camera (e.g., an RGB camera) or multiple cameras for capturing one or more images and/or one or more videos including video frames. In some aspects, the apparatus(es) includes at least one display for displaying one or more images, videos, notifications, or other displayable data. In some aspects, the apparatus(es) includes at least one transmitter configured to transmit one or more video frame and/or syntax data over a transmission medium to at least one device. In some aspects, the at least one processor includes a neural processing unit (NPU), a neural signal processor (NSP), a central processing unit (CPU), a graphics processing unit (GPU), any combination thereof, and/or other processing device or component.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and examples, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a block diagram illustrating an architecture of an image capture and processing system, in accordance with aspects of the present disclosure;

FIG. 2A is a diagram illustrating an example of a fully-connected neural network, in accordance with some examples of the present disclosure;

FIG. 2B is a diagram illustrating an example of a locally-connected neural network, in accordance with some examples of the present disclosure;

FIG. 2C is a diagram illustrating an example of a convolutional neural network, in accordance with some examples of the present disclosure;

FIG. 2D is a diagram illustrating an example of a deep convolutional network (DCN) for recognizing visual features from an image, in accordance with some examples of the present disclosure;

FIG. 3 is a block diagram illustrating an example deep convolutional network (DCN), in accordance with some examples of the present disclosure;

FIG. 4A illustrates training images, in accordance with aspects of the present disclosure;

FIG. 4B illustrates annotated training images, in accordance with aspects of the present disclosure;

FIG. 5 is a system diagram illustrating a domain-agnostic annotation and review framework, in accordance with aspects of the present disclosure;

FIG. 6A is a diagram illustrating an example of an IoU of two boxes, in accordance with aspects of the present disclosure;

FIG. 6B is a chart illustrating IoU values between segments of a frame and segments of a consecutive frame, in accordance with aspects of the present disclosure;

FIG. 7 illustrates operations of a video segment review framework, in accordance with aspects of the present disclosure;

FIG. 8 is a flow diagram illustrating a process for annotating data, in accordance with aspects of the present disclosure;

FIG. 9 is a diagram illustrating an example of a system for implementing certain aspects of the present technology.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of subject matter of the application. However, it will be apparent that various examples may be practiced without these specific details. The figures and description are not intended to be restrictive.

The ensuing description provides illustrative examples only, and is not intended to limit the scope, applicability, or configuration of the disclosure. Rather, the ensuing description will provide those skilled in the art with an enabling description for implementing the illustrative examples. It should be understood that various changes may be made in the function and arrangement of elements without departing from the spirit and scope of the application as set forth in the appended claims.

In some cases, machine learning (ML) based algorithms, such as ML models, may be trained prior to use. Training data may be used to train ML models. The training data may be annotated with ground truth information, which may indicate what the ML model in training is being trained to predict. For example, a computer vision ML model may be trained on facial images annotated with segments or keypoints of facial features, such as the lips, nose, etc. to train the computer vision ML model to detect and segment such facial features.

In some cases, annotating video for use as training data can be labor intensive, time consuming, and/or expensive. Additionally, while some pretrained tracking algorithm may be used to help extrapolate annotations across frames, such pretrained tracking algorithms may be pretrained using images from one image domain, such as color (e.g., RGB) images, and may perform poorly with images from another image domain, such as infrared images and annotations generated using such a pretrained tracking algorithm should be reviewed. Therefore, techniques for a domain agnostic annotation framework for training ML models may be useful.

Systems, apparatuses, electronic devices, methods (also referred to as processes), and computer-readable media (collectively referred to herein as “systems and techniques”) are described herein that provide a domain agnostic annotation framework for training ML models. For example, an annotation framework for annotating data may identify a keyframe from a sequence of frames. The keyframe may be identified from the sequence of frames based on features differences between frames of the received sequence of frames. In some cases, these feature differences may be determined based on a content loss between consecutive frames. The content loss may be an indication of how closely the features of a first frame matches with features of a second frame. A large content loss indicating a larger difference between features of the first frame and second frame above a threshold loss value may be used to identify the keyframe. The identified keyframe may be manually annotated.

Based on the keyframe, a first set of frames from the received sequence of frames may be identified. This first set of frames may be identified based on differences between features of frames of the received sequence of frames and the keyframe. In some cases, the differences between features of the received sequence of frames and the keyframe may be determined based on the content loss. Frames of the first set of frames may be identified based on frames with a lower content loss indicating fewer differences between features of a frame and the keyframe. Annotations of the keyframe may then be extrapolated from the keyframe to the frames of the first set of frames using a pretrained tracking algorithm. This process may be repeated for each keyframe to generate annotated frames.

The annotated frames may then be checked for potential errors in the annotations and frames with potential errors in the annotations may be extracted. In some cases, frames with potential errors may be detected based on an intersection over union (IoU) calculated for annotations between consecutive frames. In some cases, a dip in the IoU between annotations may indicate a frame with potential errors. Extracted frames may be manually annotated.

In some cases, the annotated frames may be reviewed. To help streamline review, a review framework may identify manually annotated frames from the annotated frames. A set of frames, from the annotated frames, may be identified based on differences between features of the manually annotated frame and the other frames. A video may be generated using the frames of the set of frames and a reviewer may manually review the video to verify the annotations.

Various aspects of the application will be described with respect to the figures.

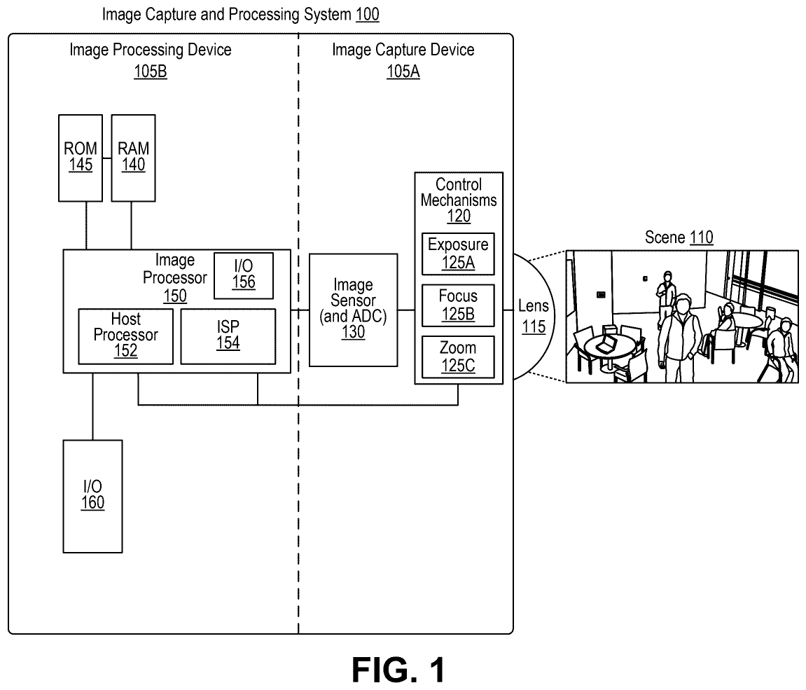

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

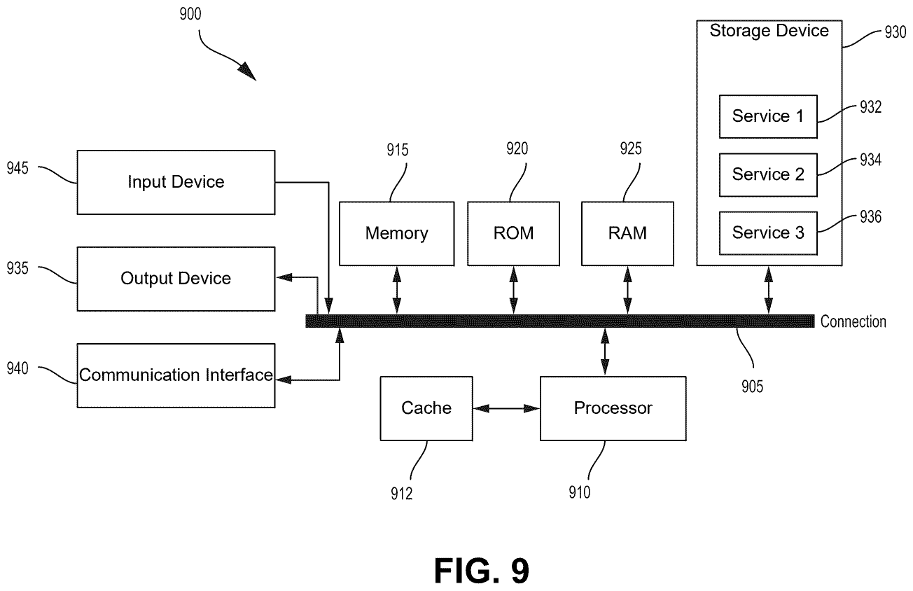

The image processor 150 may include one or more processors, such as one or more image signal processors (ISPs) (including ISP 154), one or more host processors (including host processor 152), and/or one or more of any other type of processor 910 discussed with respect to the computing system 900 of FIG. 9. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.11 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

In some cases, images captured by the image capture and processing system 100 may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

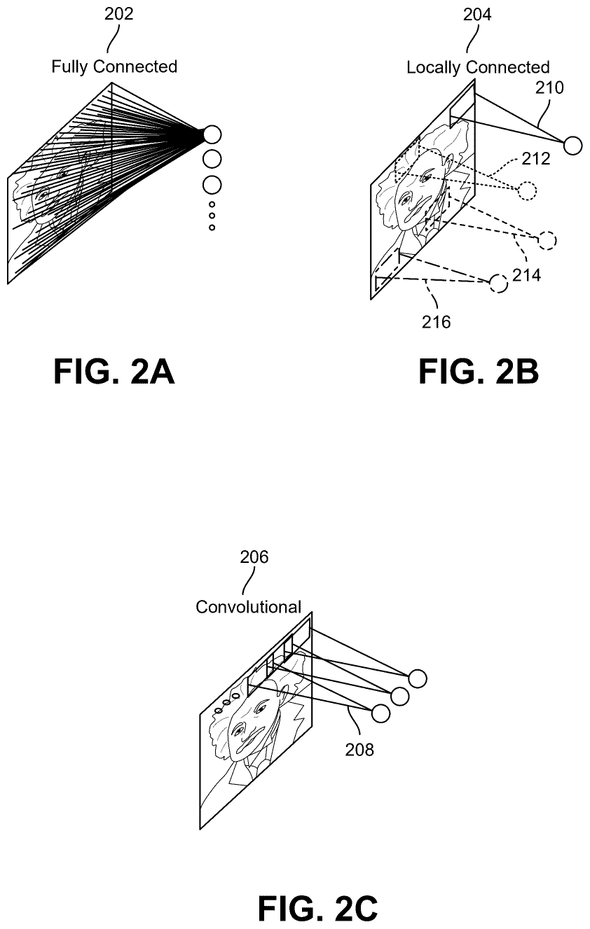

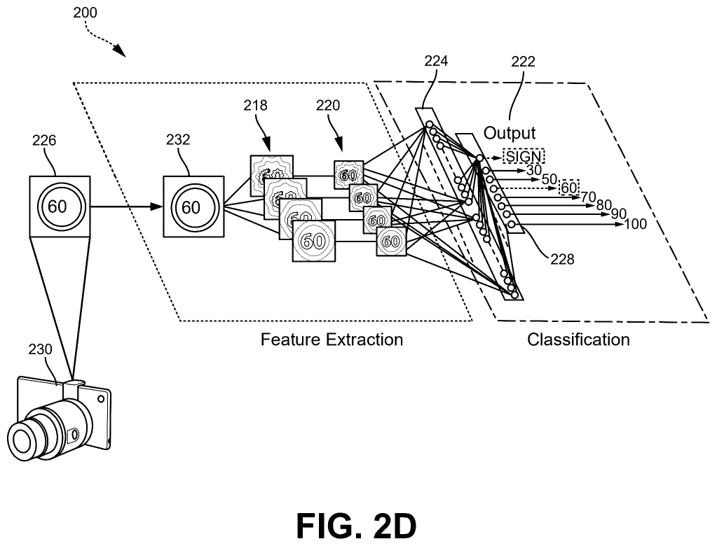

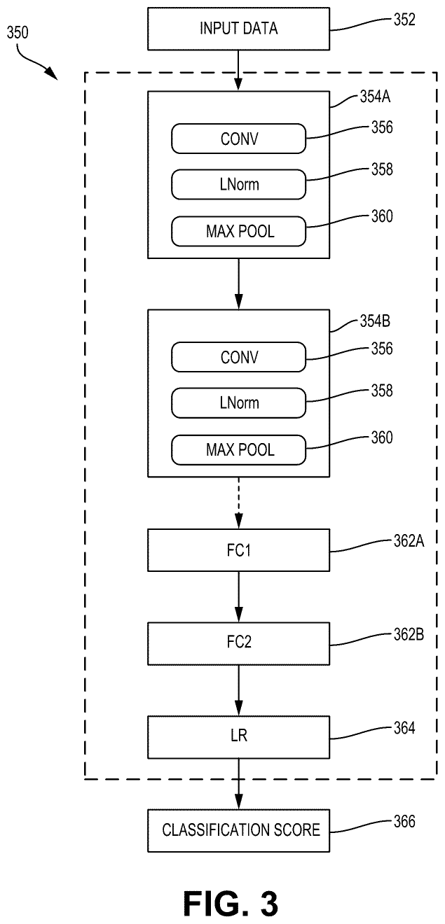

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input. The connections between layers of a neural network may be fully connected or locally connected. Various examples of neural network architectures are described below with respect to FIG. 2A-FIG. 3.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer, because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful. Convolutional neural network 206 may be used to perform one or more aspects of video compression and/or decompression, according to aspects of the present disclosure.

One type of convolutional neural network is a deep convolutional network (DCN). FIG. 2D illustrates a detailed example of a DCN 200 designed to recognize visual features from an image 226 input from an image capturing device 230, such as a image capture and processing system 100 of FIG. 1. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 is a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 is likely to be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN may be presented with new images and a forward pass through the network may yield an output 222 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., feature maps 220) receiving input from a range of neurons in the previous layer (e.g., feature maps 218) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction.

FIG. 3 is a block diagram illustrating an example of a deep convolutional network 350. The deep convolutional network 350 may include multiple different types of layers based on connectivity and weight sharing. As shown in FIG. 3, the deep convolutional network 350 includes the convolution blocks 354A, 354B. Each of the convolution blocks 354A, 354B may be configured with a convolution layer (CONV) 356, a normalization layer (LNorm) 358, and a max pooling layer (MAX POOL) 360. Of note, the layers illustrated with respect to convolution blocks 354A and 354B are examples of layers that may be included in a convolution layer and are not intended to be limiting and other types of layers may be included in any order.

The convolution layers 356 may include one or more convolutional filters, which may be applied to the input data 352 to generate a feature map. Although only two convolution blocks 354A, 354B are shown, the present disclosure is not so limiting, and instead, any number of convolution blocks (e.g., convolution blocks 354A, 354B) may be included in the deep convolutional network 350 according to design preference. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a processor such as a CPU or GPU, or any other type of processor 1110 discussed with respect to the computing system 900 of FIG. 9 to achieve high performance and low power consumption. In alternative aspects, the parallel filter banks may be loaded on a DSP or an ISP of the computing system 900 of FIG. 9. In addition, the deep convolutional network 350 may access other processing blocks that may be present on the computing system 900 of FIG. 9, such as sensor processor and navigation module, dedicated, respectively, to sensors and navigation.

The deep convolutional network 350 may also include one or more fully connected layers, such as layer 362A (labeled “FC1”) and layer 362B (labeled “FC2”). The deep convolutional network 350 may further include a logistic regression (LR) layer 364. Between each layer 356, 358, 360, 362A, 362B, 364 of the deep convolutional network 350 are weights (not shown) that are to be updated. The output of each of the layers (e.g., 356, 358, 360, 362A, 362B, 364) may serve as an input of a succeeding one of the layers (e.g., 356, 358, 360, 362A, 362B, 364) in the deep convolutional network 350 to learn hierarchical feature representations from input data 352 (e.g., images, audio, video, sensor data and/or other input data) supplied at the first of the convolution blocks 354A. The output of the deep convolutional network 350 is a classification score 366 for the input data 352. The classification score 366 may be a set of probabilities, where each probability is the probability of the input data including a feature from a set of features.

In some cases, one or more convolutional networks, such as a DCN, may be incorporated into more complex ML networks. As an example, as indicated above, the deep convolutional network 350 may output probabilities that an input data, such as an image, includes certain features. The deep convolutional network 350 may then be modified to extract (e.g., output) certain features. Additionally, DCNs may be added to extract other features as well. This set of DCNs may function as feature extractors to identify features in an image. In some cases, feature extractors may be used as a backbone for additionally ML network components to perform further operations, such as image segmentation, keypoint detection, object detection, etc.

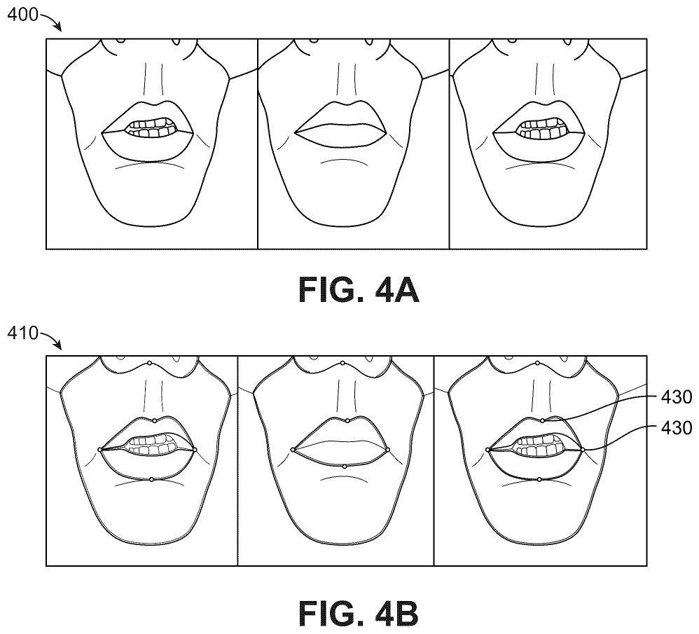

ML networks may be trained prior to use. For example, weights of an ML network may be initialized essentially randomly and then the ML networks trained using training data to learn how to make accurate predictions and/or decisions. In some cases, this training data may be annotated to help provide ground truth information for training the ML network. For example, an ML network may be trained on facial images to locate keypoints of facial features, such as the lips, nose, etc. FIG. 4A is an example of a training image 400 used to train an ML network.

The ML network being trained may generate a prediction of where the keypoints of certain facial features are in the image, and the prediction generated by the ML network may be compared to annotations 430 of the training image. FIG. 4B is an example of an annotated image 410 (e.g., an annotated version of the image 400 of FIG. 4B). The annotations 430 in the annotated image 410 indicate where the keypoints of the facial features are in the training image (e.g., as a ground truth). Weights and/or parameters of the ML network may be adjusted based on the comparison between the prediction generated by the ML network and the annotations 430 using, for example, a loss function.

While annotations are useful for training ML networks, generating annotations for training data can be expensive, time consuming, and/or labor intensive. For example, where an ML network is being trained on video, each frame of a training video clip may be annotated by a person. Further video clips (or images) taken in different image domains, such as in different wavelengths of light such as infrared or color, may be separately annotated as facial features (or other features) may appear differently depending on the image domain. Additionally, as not all annotations are initially correct, there may be system for reviewing annotations performed by an annotator and applying corrections, if needed. Therefore, a domain agnostic annotation and review framework may be useful to help generate annotated training information for ML networks.

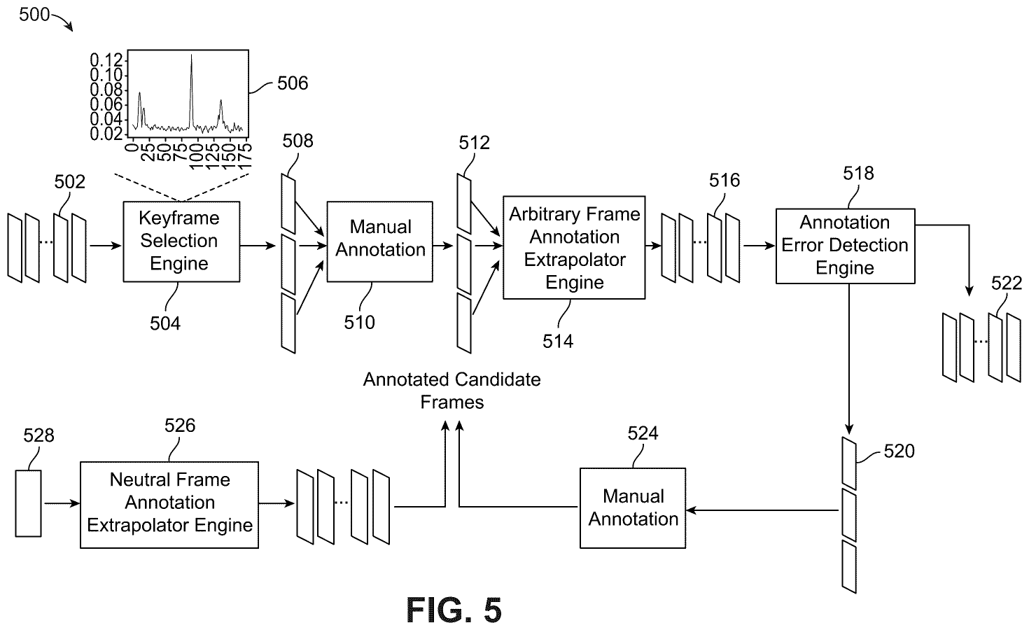

FIG. 5 is a system diagram illustrating a domain-agnostic annotation and review framework 500, in accordance with aspects of the present disclosure. In some cases, a sequence of frames 502 (e.g., a video clip) may be input to a keyframe selection engine 504. The sequence of images may be in any image domain and the sequence of images may be arranged in sequence chronologically. As videos typically include multiple frames (e.g., images) per second e.g., 30, 60, 120, etc.), videos may have redundant frames which appear very similar. In some cases, it may be useful to identify redundant frames and along with frames which are less redundant and potentially more informative for annotating. For example, the keyframe selection engine 504 may identify keyframes, which are frames that are less redundant.

The keyframe selection engine 504 may identify keyframes based on a difference in features between frames. In some cases, CNNs may capture information about content in higher layer features and it may be useful to use a CNN based feature detector to identify features of images. For example, a pretrained image feature detector, such as a VGG19 ML model may be used to obtain features for a set of images, such as for two consecutive frames (e.g., for three frames, over some number of frames, etc.). A difference between the features for the images of the set of images may be determined. In some cases, the differences as between features between frames may be determined based on a content loss function. This content loss function may be expressed as Equation 1 below.

$${L}_{content} = \frac{1}{2} {\sum }_{i . j} {( {F}_{i , j}^{l} - {P}_{i , j}^{l} )}^{2} , \qquad Equation 1$$

where L may be the output of a layer (e.g., relu4_1 layer) in a pre-trained VGG19 network to determine the features, P and F may be any two consecutive images in the video sequence, and/and P′ may be feature representations of P and F. The loss may be plotted 506 across the sequence of frames 502 to identify a set of peak losses corresponding to frames between which there are the most differences in terms of features. These peak losses may be compared to a threshold loss value to identify candidate frames 508 from the sequence of frames 502. The candidate frames 508 may be those frames which are more substantively different from a previous frame in the sequence of frames 502.

In some cases, the candidate frames 508 may be submitted for manual annotation 510, for example, by a human annotator to generate annotated candidate frames 512. The human annotator may annotate the candidate frames 508 using any technique suitable for annotating training data, such as images.

The annotated candidate frames 512 may be input to an arbitrary frame annotation extrapolator engine 514. The arbitrary frame annotation extrapolator engine 514 may be used to extrapolate annotations from the annotated candidate frames 512 to other frames of the sequence of frames 502. In some cases, the arbitrary frame annotation extrapolator engine 514 may leverage a pretrained, ML based, tracking algorithm, such as CoTracker. In some cases, pretrained tracking algorithms may be pretrained using video from one image domain, such as for color (e.g., RGB) images/video and these pretrained tracking algorithms may perform relatively poorly with images/video in another image domain, such as for infrared images/video.

Rather than attempting to retrain a pretrained tracking algorithm, it may be easier to identify frames from the sequence of frames 502 which are relatively similar to certain images, such as the candidate frames and run the pretrained tracking algorithm for the identified frames. For example, for annotated candidate frame K, of the annotated candidate frames 512, a frame Cₖ with minimum content loss (e.g., are the most similar) to the annotated candidate frame K may be found. For example, features of the frames of the sequence of frames 502 may be determined. Differences between the features of the annotated candidate frame K and the other frames of the sequence of frames 502 may be determined to identify the frame Cₖ with a minimum content loss. This difference may be determined by the content loss function, Equation 1, above. Locating the frame Cₖ with a minimum content loss from among the sequence of frames 502 can be expressed as: argmin L_{content} (F, Cₖ).

Other frames similar to the annotated candidate frame K may be clustered with the annotated candidate frame K. For example, other frames of the sequence of frames 502 associated with a content loss below a threshold value (e.g., other frames having similar features to the annotated candidate frame K within a threshold amount) may be identified and arranged with the annotated candidate frame K to form a cluster of frames. In some cases, this threshold value may be tuned based on how well the pretrained tracking algorithm can handle differences of features for images/video in the image domain of the sequence of frames 502. In some cases, the threshold which peak losses are compared to (e.g., by the keyframe selection engine 504) may also be tuned based on how well the pretrained tracking algorithm can handle differences of features for images/video in the image domain of the sequence of frames 502. The pretrained tracking algorithm may be used to track and extrapolate keypoints from the annotated candidate frame K to the other frames of the cluster of frames to annotate the other frames of the cluster of frames based on the annotated candidate frame K. The arbitrary frame annotation extrapolator engine 514 may iterate across all of the annotated candidate frames 512 to extrapolate the keypoints from an annotated candidate frame to annotate the other frames associated with the annotated candidate frame and generate an annotated image sequence 516.

The annotated image sequence 516 may be passed to an annotation error detection engine 518. In some cases, as pretrained tracking algorithms may not have been specifically trained to operate in the image domain associated with the sequence of frames 502, the pretrained tracking algorithms may not be as reliable as they otherwise may be in another image domain. For example, image domain differences, such as differences between how a feature may appear in one image domain and another image domain, can make feature point tracking by a tracking algorithm more prone to providing erroneous results. The annotation error detection engine 518 may detect frames with such potentially erroneous results and extract those frames with as new candidate frames 520. Frames not associated with potentially erroneous results may be output as annotated frames 522.

The new candidate frames 520 may be submitted for manual annotation 524, for example, by a human annotator to generate annotated candidate frames 512. These annotated candidate frames 512 may be input to the arbitrary frame annotation extrapolator engine 514 as discussed above. This loop may repeat until all frames of the sequence of frames 502 have been output as annotated frames 522.

In some cases, the sequence of frames 502 intended for training may be organized such that each sequence of frames 502 begins with a face expressing a neutral expression (e.g., expression of the face at rest). The face then expresses a target expression (e.g., happy, sad, cringe, etc.) and then returns to the neutral expression. In such cases, a mechanism that can recognize and generate annotations for the neutral frames efficiently may be useful to help exploit the spatial similarity between frames while ignoring the temporal context. In some cases, a neutral frame annotation extrapolator engine 526 may be used to identify and annotate the neutral frames. For example, a neutral frame 528 (either from the sequence of frames 502 or from another sequence of frames (e.g., video clip/frames independent of the sequence of frames 502) for a person in the sequence of frames 502) may be manually annotated and passed to the neutral frame annotation extrapolator engine 526.

The neutral frame annotation extrapolator engine 526 may scan the sequence of frames 502 to locate a frame Cₖ with minimum content loss (e.g., are the most similar) with respect to the neutral frame 528. For example, features of the neutral frame 528 may be determined and a difference between the features of the neutral frame 528 and the other frames of the sequence of frames 502 may also be determined. This difference may be determined by the content loss function, Equation 1, above. Locating the frame Cₖ with a minimum content loss from among the sequence of frames 502 can be expressed as: argmin L_{content} (F, Cₖ). Other frames similar to frame Cₖ may be clustered with frame Cₖ. For example, other frames of the sequence of frames 502 associated with a content loss below a threshold value (e.g., other frames having similar features to frame Cₖ within a threshold amount) may be identified and arranged with frame Cₖ to generate a cluster of frames. A pretrained tracking algorithm may then be used to track and extrapolate keypoints from frame Cₖ to the other frames of the cluster of frames to annotate the other frames of the cluster of frames based on frame Cₖ to generate annotated candidate frames 512. The annotated candidate frames may be input to the arbitrary frame annotation extrapolator engine 514 as discussed above.

As indicated above, the annotation error detection engine 518 may detect frames with potentially erroneous results. In some cases, frames when have annotation errors may have a sudden change in the annotated segments, as compared to a previous frame. To account for this, the annotation error detection engine 518 may detect frames with potentially erroneous results based on an intersection over union (IoU) for annotations between consecutive frames. For example, where images are annotated based on keypoints, a segment may be drawn based the keypoints (e.g., around the keypoints) and an IoU performed for the segment across consecutive frames to detect frames with potentially erroneous results.

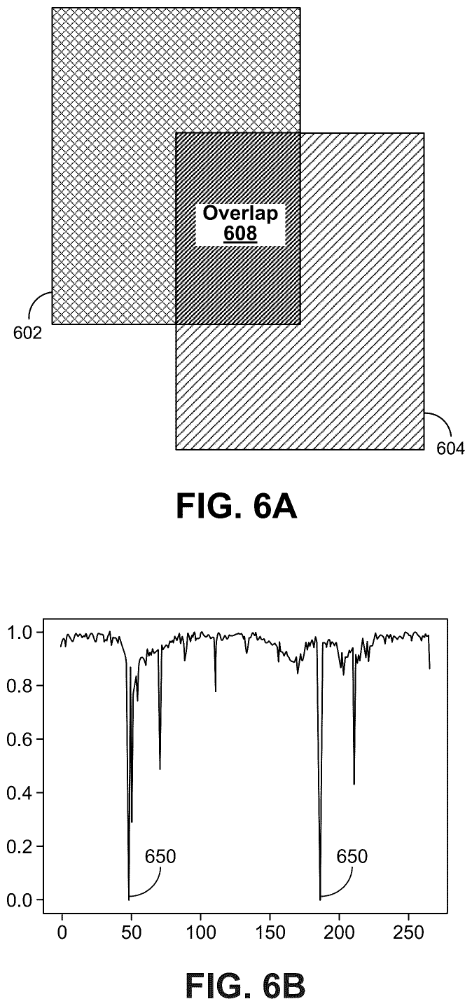

FIG. 6A is a diagram illustrating an example of an IoU of two boxes. In this example, boxes are used in place of segments for simplicity and the concepts discussed herein with respect to boxes may apply to segments as well. In some cases, the IoU may compare a first box 302 (e.g., segment) in a first frame Fᵢ and a second box 304 in a second frame Fᵢ₊₁, where i is a frame number. An area of overlap for the segments may be determined based on an overlapping area 308 in which the first box 302 overlaps with the second box 304. An area of union may represent an area of both the first box 302 and the second box 304 (e.g., the total shaded area of the first box 302 with the second box 304 (overlapping area 308 is counted oce). Thus, the IoU may be expressed as

$$IoU = \frac{Area of overlap of segments between Fi and Fi + 1}{Area of union of segments between Fi and Fi + 1} .$$

FIG. 6B is a chart illustrating IoU values between segments of a frame and segments of a consecutive frame. In some cases, the annotated error detection engine (e.g., annotation error detection engine 518 of FIG. 5) may determine the IoU of consecutive frames and detect sudden dips 650 in the IoU between consecutive frames. Where the IoU dips below a certain threshold, those frames may be selected for manual annotation (e.g., as new candidate frames 520 of FIG. 5 for manual annotation 524 of FIG. 5) as potentially having erroneous results.

In some cases, it may be useful to review the annotated frames (e.g., annotated frames 522 of FIG. 5) as output by a domain-agnostic annotation and review framework. In some cases, review of the annotated frames may be performed using a video segment review framework.

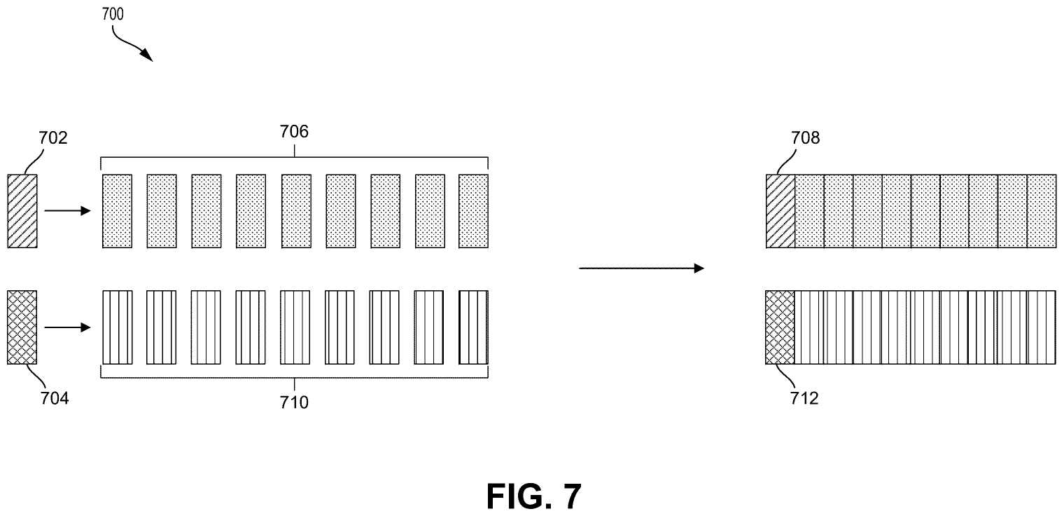

FIG. 7 illustrates operations of a video segment review framework 700, in accordance with aspects of the present disclosure. In some cases, the video segment review framework 700 may operate in a manner similar to the arbitrary frame annotation extrapolator engine and/or neutral frame annotation extrapolator engine. In some cases, the video segment review framework 700 may initially identify manually annotated candidate frames (e.g., annotated candidate frames 512 of FIG. 5) from the sequence of frames as key frames, such as a first key frame 702 and a second key frame 704. For example, frames may include associated metadata indicating whether the frame had been manually annotated or annotated using extrapolated annotations. Frames, of the sequence of frames, which are similar to a key frame may be clustered with the key frame. For example, a first set of frames 706, from the sequence of frames, with a minimum content loss (e.g., are the most similar) with the first key frame 702 may be clustered together with the first key frame 702 to generate a first video segment 708. The first set of frames 706 having a minimum content loss as compared to the first key frame 702 may be determined based on Equation 1, above. Similarly, a second set of frames 710 with a minimum content loss with the second key frame 704 may be clustered together with the second key frame 704 to generate a second video segment 712. This process to generate video segments associated with a key frame may be repeated for each key frame.

In some cases, if there is an annotation error in a frame of a video segment (e.g., cluster), most, if not all, of the frames of the video segment would have a similar error. Each video segment may be reviewed, for example, by a human reviewer and the reviewer may approve/disapprove of the annotations in the entire video segment at once. If a reviewer disapproves of the annotations in a video sequence, such as the second video segment 712, an index of the frames (e.g., indicating where in the sequence of frames the frames of the second video segment 712 are located) of the second video segment 712 may be obtained and these frames may be returned to an annotator as error cases for reannotation of the frames. In some cases, the annotator may be able to reannotate the key frame (e.g., second key frame 704) and extrapolate the reannotations across the frames of the second video segment 712 to make the error correction.

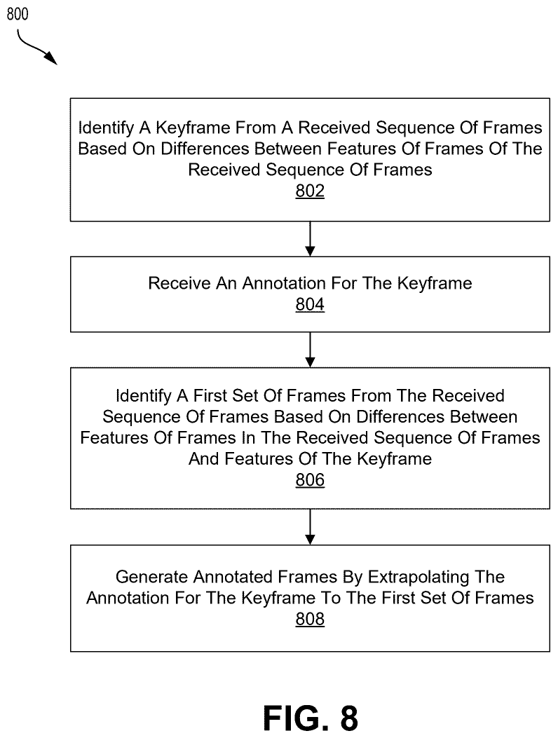

FIG. 8 is a flow diagram illustrating a process 800 for annotating data, in accordance with aspects of the present disclosure. The process 800 may be performed by a computing device (or apparatus) or a component (e.g., a chipset, codec, etc.) of the computing device (e.g., image capturing and processing system 100 of FIG. 1, image capturing device 230 of FIG. 2D, computing system 900 of FIG. 9, etc.). The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 800 may be implemented as software components that are executed and run on one or more processors (e.g., the image processor 150 of FIG. 1, the host processor 152 of FIG. 1, processor 910 of FIG. 9, and/or other processor(s)). In some cases, the operations of the process 800 can be implemented by a system having the architecture of computing system 900 of FIG. 9.

At block 802, the computing device (or component thereof) may identify a keyframe from a received sequence of frames based on differences between features of frames of the received sequence of frames (e.g., sequence of frames 502 of FIG. 5). For example, differences of features between frames may be determined based on a content loss function and peak losses may be compared to a threshold loss value to identify candidate frames. In some cases, the identified keyframe is manually annotated.

In some cases, the computing device (or component thereof) may obtain an annotated neutral frame (e.g., neutral frame 528 of FIG. 5); identify a second set of frames from the received sequence of frames based on differences between features of frames in the second set of frames and the annotated neutral frame; and generate an annotated second set of frames by extrapolating annotations of the annotated neutral frame. For example, a neutral frame (either from the sequence of frames or from another sequence of frames (e.g., video clip/frames independent of the sequence of frames) for a person in the sequence of frames) may be manually annotated and passed to the neutral frame annotation extrapolator engine. The neutral frame annotation extrapolator engine may scan the sequence of frames to locate a frame Cₖ with minimum content loss (e.g., are the most similar) with respect to the neutral frame, and a pretrained tracking algorithm may then be used to track and extrapolate keypoints from frame Cₖ to the other frames of the cluster of frames to annotate the other frames of the cluster of frames based on frame Cₖ to generate annotated candidate frames.

At block 804, the computing device (or component thereof) may receive an annotation for the keyframe. For example, the candidate frames may be submitted for manual annotation, for example, by a human annotator to generate annotated candidate frames.

At block 806, the computing device (or component thereof) may identify a first set of frames from the received sequence of frames based on differences between features of frames in the received sequence of frames and features of the keyframe. In some cases, the computing device (or component thereof) may detect a set of features for each frame of the received sequence of frames. In some examples, the differences between the features of the frames of the received sequence of frames is determined based on a content loss between consecutive frames of the received sequence of frames, and wherein the keyframe is identified by comparing the content loss between the consecutive frames to identify frames with the content loss above a threshold loss value.

At block 808, the computing device (or component thereof) may generate annotated frames by extrapolating the annotation for the keyframe to the first set of frames. For example, the annotated candidate frames may be input to an arbitrary frame annotation extrapolator engine and the arbitrary frame annotation extrapolator engine may be used to extrapolate annotations from the annotated candidate frames to other frames of the sequence of frames. In some cases, the computing device (or component thereof) may detect frames with potential errors from the annotated frames; and extract the detected frames for manual annotation. For example, an annotation error detection engine may detect frames with potentially erroneous results and extract those frames with as new candidate frames. In some examples, the detected frames with potential errors are detected based on an intersection over union for annotations between consecutive frames. In some cases, the differences between features of frames in the first set of frames and the keyframe is determined based on a content loss between a frame of the received sequence of frames and the keyframe, and wherein the first set of frames are identified by comparing the content loss between a frame of the received sequence of frames and the keyframe to identify frames with content loss less than a threshold content loss value. In some examples, extrapolating the annotation for the keyframe to the first set of frames is performed using a pretrained tracking algorithm.

In some cases, the computing device (or component thereof) may identify a manually annotated frame of the annotated frames; identify a third set of frames from the annotated frames based on differences between features of the manually annotated frame and other frames of the annotated frames; and generate a video segment (e.g., first video segment 708 of FIG. 7, second video segment 712 of FIG. 7, etc.) using the third set of frames to review annotations in the third set of frames. For example, frames may include associated metadata indicating whether the frame had been manually annotated and identify manually annotated candidate frames from the sequence of frames as key frames. Frames, of the sequence of frames, which are similar to a key frame may be clustered with the key frame to generate a first video segment.

In some examples, the techniques or processes described herein may be performed by a computing device, an apparatus, and/or any other computing device. In some cases, the computing device or apparatus may include a processor, microprocessor, microcomputer, or other component of a device that is configured to carry out the steps of processes described herein. In some examples, the computing device or apparatus may include a camera configured to capture video data (e.g., a video sequence) including video frames. For example, the computing device may include a camera device, which may or may not include a video codec. As another example, the computing device may include a mobile device with a camera (e.g., a camera device such as a digital camera, an IP camera or the like, a mobile phone or tablet including a camera, or other type of device with a camera). In some cases, the computing device may include a display for displaying images. In some examples, a camera or other capture device that captures the video data is separate from the computing device, in which case the computing device receives the captured video data. The computing device may further include a network interface, transceiver, and/or transmitter configured to communicate the video data. The network interface, transceiver, and/or transmitter may be configured to communicate Internet Protocol (IP) based data or other network data.

The processes described herein can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

In some cases, the devices or apparatuses configured to perform the operations of the process 800 and/or other processes described herein may include a processor, microprocessor, micro-computer, or other component of a device that is configured to carry out the steps of the process 800 and/or other process. In some examples, such devices or apparatuses may include one or more sensors configured to capture image data and/or other sensor measurements. In some examples, such computing device or apparatus may include one or more sensors and/or a camera configured to capture one or more images or videos. In some cases, such device or apparatus may include a display for displaying images. In some examples, the one or more sensors and/or camera are separate from the device or apparatus, in which case the device or apparatus receives the sensed data. Such device or apparatus may further include a network interface configured to communicate data.

The components of the device or apparatus configured to carry out one or more operations of the process 800 and/or other processes described herein can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 800 is illustrated as a logical flow diagrams, the operations of which represent sequences of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein (e.g., the process 800 and/or other processes) may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 9 is a diagram illustrating an example of a system for implementing certain aspects of the present technology. In particular, FIG. 9 illustrates an example of computing system 900, which can be for example any computing device making up internal computing system, a remote computing system, a camera, or any component thereof in which the components of the system are in communication with each other using connection 905. Connection 905 can be a physical connection using a bus, or a direct connection into processor 910, such as in a chipset architecture. Connection 905 can also be a virtual connection, networked connection, or logical connection.

In some examples, computing system 900 is a distributed system in which the functions described in this disclosure can be distributed within a datacenter, multiple data centers, a peer network, etc. In some examples, one or more of the described system components represents many such components each performing some or all of the functions for which the component is described. In some cases, the components can be physical or virtual devices.

Example computing system 900 includes at least one processing unit (CPU or processor) 910 and connection 905 that couples various system components including system memory 915, such as read-only memory (ROM) 920 and random access memory (RAM) 925 to processor 910. Computing system 900 can include a cache 912 of high-speed memory connected directly with, in close proximity to, or integrated as part of processor 910.

Processor 910 can include any general purpose processor and a hardware service or software service, such as services 932, 934, and 936 stored in storage device 930, configured to control processor 910 as well as a special-purpose processor where software instructions are incorporated into the actual processor design. Processor 910 may be a completely self-contained computing system, containing multiple cores or processors, a bus, memory controller, cache, etc. A multi-core processor may be symmetric or asymmetric.

To enable user interaction, computing system 900 includes an input device 945, which can represent any number of input mechanisms, such as a microphone for speech, a touch-sensitive screen for gesture or graphical input, keyboard, mouse, motion input, speech, camera, accelerometers, gyroscopes, etc. Computing system 900 can also include output device 935, which can be one or more of a number of output mechanisms. In some instances, multimodal systems can enable a user to provide multiple types of input/output to communicate with computing system 900. Computing system 900 can include communications interface 940, which can generally govern and manage the user input and system output. The communication interface may perform or facilitate receipt and/or transmission of wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 930 can include software services, servers, services, etc., that when the code that defines such software is executed by the processor 910, it causes the system to perform a function. In some examples, a hardware service that performs a particular function can include the software component stored in a computer-readable medium in connection with the necessary hardware components, such as processor 910, connection 905, output device 935, etc., to carry out the function.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some examples, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the examples provided herein. However, it will be understood by one of ordinary skill in the art that the examples may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the examples in unnecessary detail. In other instances, well-known circuits, processes, algorithms, structures, and techniques may be shown without unnecessary detail in order to avoid obscuring the examples.

Individual examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the present disclosure include:
Aspect 1. An apparatus for annotating data, comprising: at least one memory; and at least one processor coupled to the at least one memory, the at least one processor being configured to: identify a keyframe from a received sequence of frames based on differences between features of frames of the received sequence of frames; receive an annotation for the keyframe; identify a first set of frames from the received sequence of frames based on differences between features of frames in the received sequence of frames and features of the keyframe; and generate annotated frames by extrapolating the annotation for the keyframe to the first set of frames.
Aspect 2. The apparatus of Aspect 1, wherein the at least one processor is configured to: detect frames with potential errors from the annotated frames; and extract the detected frames for manual annotation.
Aspect 3. The apparatus of Aspect 2, wherein the detected frames with potential errors are detected based on an intersection over union for annotations between consecutive frames.
Aspect 4. The apparatus of any of Aspects 1-3, wherein the at least one processor is configured to: obtain an annotated neutral frame; identify a second set of frames from the received sequence of frames based on differences between features of frames in the second set of frames and the annotated neutral frame; and generate an annotated second set of frames by extrapolating annotations of the annotated neutral frame.
Aspect 5. The apparatus of Aspect 4, wherein the annotated neutral frame is independent of the received sequence of frames.
Aspect 6. The apparatus of any of Aspects 1-5, wherein the at least one processor is configured to detect a set of features for each frame of the received sequence of frames.
Aspect 7. The apparatus of Aspect 6, wherein the differences between the features of the frames of the received sequence of frames is determined based on a content loss between consecutive frames of the received sequence of frames, and wherein the keyframe is identified by comparing the content loss between the consecutive frames to identify frames with the content loss above a threshold loss value.
Aspect 8. The apparatus of Aspect 6, wherein the differences between features of frames in the first set of frames and the keyframe is determined based on a content loss between a frame of the received sequence of frames and the keyframe, and wherein the first set of frames are identified by comparing the content loss between a frame of the received sequence of frames and the keyframe to identify frames with content loss less than a threshold content loss value.
Aspect 9. The apparatus of any of Aspects 1-8, wherein the at least one processor is configured to: identify a manually annotated frame of the annotated frames; identify a third set of frames from the annotated frames based on differences between features of the manually annotated frame and other frames of the annotated frames; and generate a video segment using the third set of frames to review annotations in the third set of frames.
Aspect 10. The apparatus of any of Aspects 1-9, wherein extrapolating the annotation for the keyframe to the first set of frames is performed using a pretrained tracking algorithm.
Aspect 11. The apparatus of any of Aspects 1-10, wherein the identified keyframe is manually annotated.
Aspect 12. A method for annotating data, comprising: identifying a keyframe from a received sequence of frames based on differences between features of frames of the received sequence of frames; receiving an annotation for the keyframe; identifying a first set of frames from the received sequence of frames based on differences between features of frames in the received sequence of frames and features of the keyframe; and generating annotated frames by extrapolating the annotation for the keyframe to the first set of frames.
Aspect 13. The method of Aspect 12, further comprising: detecting frames with potential errors from the annotated frames; and extracting the detected frames for manual annotation.
Aspect 14. The method of Aspect 13, wherein the detected frames with potential errors are detected based on an intersection over union for annotations between consecutive frames.
Aspect 15. The method of any of Aspects 12-14, further comprising: obtaining an annotated neutral frame; identifying a second set of frames from the received sequence of frames based on differences between features of frames in the second set of frames and the annotated neutral frame; and generating an annotated second set of frames by extrapolating annotations of the annotated neutral frame.
Aspect 16. The method of Aspect 15, wherein the annotated neutral frame is independent of the received sequence of frames.
Aspect 17. The method of any of Aspects 12-16, further comprising detecting a set of features for each frame of the received sequence of frames.
Aspect 18. The method of Aspect 17, wherein the differences between the features of the frames of the received sequence of frames is determined based on a content loss between consecutive frames of the received sequence of frames, and wherein the keyframe is identified by comparing the content loss between the consecutive frames to identify frames with the content loss above a threshold loss value.
Aspect 19. The method of Aspect 17, wherein the differences between features of frames in the first set of frames and the keyframe is determined based on a content loss between a frame of the received sequence of frames and the keyframe, and wherein the first set of frames are identified by comparing the content loss between a frame of the received sequence of frames and the keyframe to identify frames with content loss less than a threshold content loss value.
Aspect 20. The method of any of Aspects 12-19, further comprising: identifying a manually annotated frame of the annotated frames; identifying a third set of frames from the annotated frames based on differences between features of the manually annotated frame and other frames of the annotated frames; and generating a video segment using the third set of frames to review annotations in the third set of frames.
Aspect 21. The method of any of Aspects 12-20, wherein extrapolating the annotation for the keyframe to the first set of frames is performed using a pretrained tracking algorithm.
Aspect 22. The method of any of Aspects 12-21, wherein the identified keyframe is manually annotated.
Aspect 23. A non-transitory computer-readable medium having stored thereon instructions that, when executed by at least one processor, cause the at least one processor to perform one or more of operations according to any of Aspects 12 to 22.
Aspect 34: An apparatus for annotating data, comprising means for performing one or more of operations according to any of Aspects 12 to 22.
Aspect 35: The method of Aspect 17, wherein the differences between features of frames in the first set of frames and the keyframe is determined based on a content loss between a frame of the received sequence of frames and a set of keyframes, and wherein the first set of frames are identified by selecting they keyframe, of the set of keyframes, with a least content loss for the frames of the received sequence of frames.
Aspect 36: The apparatus of Aspect 6, wherein the differences between features of frames in the first set of frames and the keyframe is determined based on a content loss between a frame of the received sequence of frames and a set of keyframes, and wherein the first set of frames are identified by selecting they keyframe, of the set of keyframes, with a least content loss for the frames of the received sequence of frames.

What is claimed is:

1. An apparatus for annotating data, comprising:
at least one memory; and
at least one processor coupled to the at least one memory, the at least one processor being configured to:
identify a keyframe from a received sequence of frames based on differences between features of frames of the received sequence of frames;
receive an annotation for the keyframe;
identify a first set of frames from the received sequence of frames based on differences between features of frames in the received sequence of frames and features of the keyframe; and
generate annotated frames by extrapolating the annotation for the keyframe to the first set of frames.

2. The apparatus of claim 1, wherein the at least one processor is configured to:
detect frames with potential errors from the annotated frames; and
extract the detected frames for manual annotation.

3. The apparatus of claim 2, wherein the detected frames with potential errors are detected based on an intersection over union for annotations between consecutive frames.

4. The apparatus of claim 1, wherein the at least one processor is configured to:
obtain an annotated neutral frame;
identify a second set of frames from the received sequence of frames based on differences between features of frames in the second set of frames and the annotated neutral frame; and
generate an annotated second set of frames by extrapolating annotations of the annotated neutral frame.

5. The apparatus of claim 4, wherein the annotated neutral frame is independent of the received sequence of frames.

6. The apparatus of claim 1, wherein the at least one processor is configured to detect a set of features for each frame of the received sequence of frames.

7. The apparatus of claim 6, wherein the differences between the features of the frames of the received sequence of frames is determined based on a content loss between consecutive frames of the received sequence of frames, and wherein the keyframe is identified by comparing the content loss between the consecutive frames to identify frames with the content loss above a threshold loss value.

8. The apparatus of claim 6, wherein the differences between features of frames in the first set of frames and the keyframe is determined based on a content loss between a frame of the received sequence of frames and a set of keyframes, and wherein the first set of frames are identified by selecting they keyframe, of the set of keyframes, with a least content loss for the frames of the received sequence of frames.

9. The apparatus of claim 1, wherein the at least one processor is configured to:
identify a manually annotated frame of the annotated frames;
identify a third set of frames from the annotated frames based on differences between features of the manually annotated frame and other frames of the annotated frames; and
generate a video segment using the third set of frames to review annotations in the third set of frames.

10. The apparatus of claim 1, wherein extrapolating the annotation for the keyframe to the first set of frames is performed using a pretrained tracking algorithm.

11. The apparatus of claim 1, wherein the identified keyframe is manually annotated.

12. A method for annotating data, comprising:
identifying a keyframe from a received sequence of frames based on differences between features of frames of the received sequence of frames;
receiving an annotation for the keyframe;
identifying a first set of frames from the received sequence of frames based on differences between features of frames in the received sequence of frames and features of the keyframe; and
generating annotated frames by extrapolating the annotation for the keyframe to the first set of frames.

13. The method of claim 12, further comprising:
detecting frames with potential errors from the annotated frames; and
extracting the detected frames for manual annotation.

14. The method of claim 13, wherein the detected frames with potential errors are detected based on an intersection over union for annotations between consecutive frames.

15. The method of claim 12, further comprising:
obtaining an annotated neutral frame;
identifying a second set of frames from the received sequence of frames based on differences between features of frames in the second set of frames and the annotated neutral frame; and
generating an annotated second set of frames by extrapolating annotations of the annotated neutral frame.

16. The method of claim 15, wherein the annotated neutral frame is independent of the received sequence of frames.

17. The method of claim 12, further comprising detecting a set of features for each frame of the received sequence of frames.

18. The method of claim 17, wherein the differences between the features of the frames of the received sequence of frames is determined based on a content loss between consecutive frames of the received sequence of frames, and wherein the keyframe is identified by comparing the content loss between the consecutive frames to identify frames with the content loss above a threshold loss value.

19. The method of claim 17, wherein the differences between features of frames in the first set of frames and the keyframe is determined based on a content loss between a frame of the received sequence of frames and a set of keyframes, and wherein the first set of frames are identified by selecting they keyframe, of the set of keyframes, with a least content loss for the frames of the received sequence of frames.

20. The method of claim 12, further comprising:
identifying a manually annotated frame of the annotated frames;
identifying a third set of frames from the annotated frames based on differences between features of the manually annotated frame and other frames of the annotated frames; and
generating a video segment using the third set of frames to review annotations in the third set of frames.
